(19) United States
(12) Patent Application Publication
(10) Pub. No.: US 2007/0079170 A1
(43) Pub. Date: Apr. 5, 2007

(54) Data migration in response to predicted disk failure

(76) Inventors: Vincent J. Zimmer, Federal Way, WA (US); Michael A. Rothman, Puyllup, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/242,167

(22) Filed: Sep. 30, 2005

(51) Int. Cl. G06F 11/00

(52) U.S. Cl. 714/6

(57) ABSTRACT

Disk failures can be statistically predicted at the platform level using information about disks attached to the storage platform and other platform-specific information. In one embodiment, the present invention includes collecting information about a plurality of disks, and predicting that an errant disk has a high likelihood of failure based on the information collected about the plurality of disks. In one embodiment, the invention also includes automatically migrating data from the errant disk to a health disk. In one embodiment, the migration is performed by triggering a RAID mirror event. Other embodiments are described and claimed.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

1. Field

Embodiments of the present invention relate generally to the field of data storage. More particularly, embodiments of the present invention relate to disk failure prediction.

2. Description of the Related Art

Modem enterprises have an ever-increasing need for storing data. To accommodate this need, various data storage technologies, such as Storage Area Networks (SAN) and Network Attached Storage (NAS), have been developed to provide network based data storage to client machines using storage servers. Some data, because of higher importance or legislation, must be stored in memory providing additional reliability.

Data stored on disk can be lost or compromised with the disk fails. Disk failure can have several causes, ranging from mechanical problems to electrical problems. One prior art solution to save data on disks that are likely to fail is the Self-Monitoring Analysis and Reporting Technology (SMART). An example of SMART working in a prior art storage server is now discussed with reference to FIG. 1. Client machine 5 is connected to storage server 10 via some network connection, e.g. over a LAN (not shown). The storage server 10 is connected to a storage device 20 (or multiple storage devices) over another network connection, e.g. a SCSI or Fibre Channel network (not shown).

The storage server 10 includes a network controller 16 to interface with the network to which the client 5 is attached, and a disk controller to interface with the network to which the storage device 20 is attached. The storage server 10 also includes a processor 12 to process the data requests from the client 5 for data stored on the storage device 20. The processor is coupled to a memory 14 storing various intermediate data, configuration tables, and the operating system executing on the storage server 10.

The storage device 20 includes one or more hard disk drives, represented in FIG. 1 as disk 22, 24, and 26. Disk 24 and disk 26 are shown to be provided with SMART. SMART includes a suite of diagnostics that monitor the internal operations of a disk drive and provide an early warning for certain types of predictable disk failures. When SMART predicts that a disk is likely to fail it sends an alert (as shown in FIG. 1) to an administrator. The administrator must then evaluate the alert and, if serious, dispatch a technician to replace the errant disk before it fails.

With ever-increasing size in the memory that requires more reliability, the protection offered by SMART is not enough. SMART is an alert-only system that is reactive. Furthermore, not all disks are equipped with SMART and it adds cost on a per-drive basis.

Other disk integrity schemes are also reactive in the sense that they react to disk failure. One such scheme is Redundant Array of Independent Disks (RAID). RAID provides fault-tolerance via redundancy. For example, in RAID 1 or RAID 0, data is redundantly stored on a duplicate disk. RAID is “reactive” though in that the RAID controller waits for a failure in order to restore data from a redundant disk spindle.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram illustrating a prior art Self Monitoring Analysis and Reporting Technology (SMART) system operating in the context of a storage server;

FIG. 2 is a block diagram illustrating an example storage environment in which various embodiments of the present invention may be implemented;

FIG. 3 is a block diagram illustrating a storage array controller according to one embodiment of the present invention;

FIG. 4 is a flow diagram illustrating disk failure prediction according to one embodiment of the present invention;

FIG. 5 is a flow diagram illustrating data migration according to one embodiment of the present invention; and

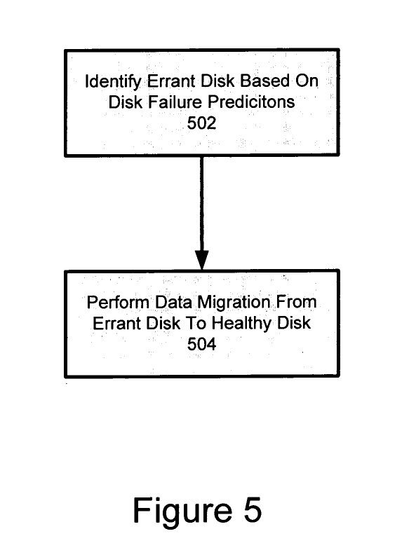

FIG. 6 is a block diagram illustrating an example computing system in which various embodiments of the present invention may be implemented.

### DETAILED DESCRIPTION

Example Storage Environment

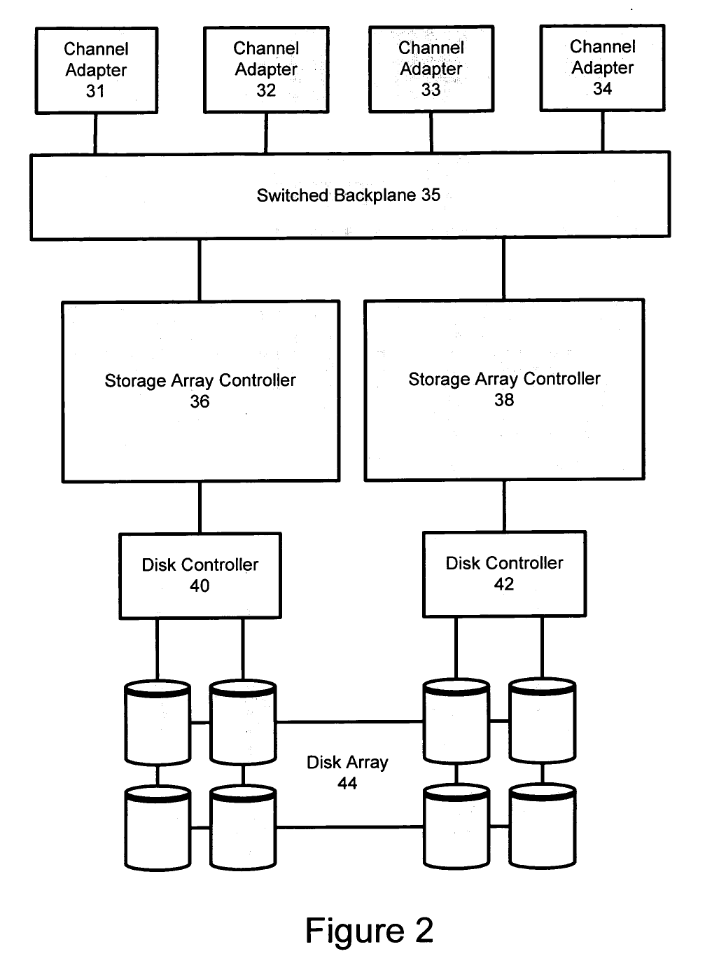

An example storage environment in which one embodiment of the present invention may be implemented is now described with reference to FIG. 2. In one embodiment, channel adapters 31-34 connect to a SAN fabric, and are the first stop for request from clients. The channel adapters 31-34 are connected to a switched backplane 35. The switched backplane 35 may be implemented to be fault-tolerant and non-blocking.

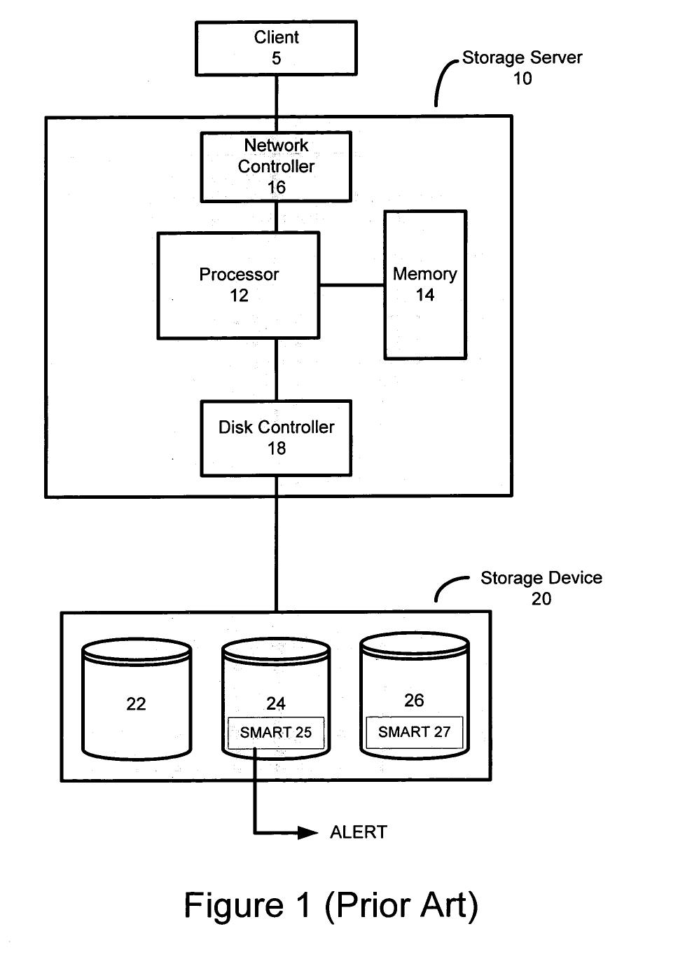

Storage array controllers 36 and 38 are coupled to the switched backplane 35. In one embodiment, storage array controller 36 is roughly analogous to a storage server, such as storage server 10 in FIG. 1. However, storage array controller 36 can include additional functionality, such as execution of the Redundant Array of Independent Disks (RAID) software stack.

Storage array controller 36 is connected to disk controller 40. Similarly, storage array controller 38 is connected to disk controller 42. The disk controllers 40 and 42 control the disk array 44. The disk array can be implemented using SCSI, Fibre Channel Abbreviated Loop (FC-AL) or some other networking protocol. The hard disk drives in the disk array 44 may or may not be provisioned with SMART. In one embodiment of the present invention, the storage array controllers 36 and 38 are provisioned with firmware or software allowing them to predict an errant disk in the disk array 44 and to automatically safeguard endangered data by migrating data from the errant disk to a safe disk.

Example Storage Array Controller

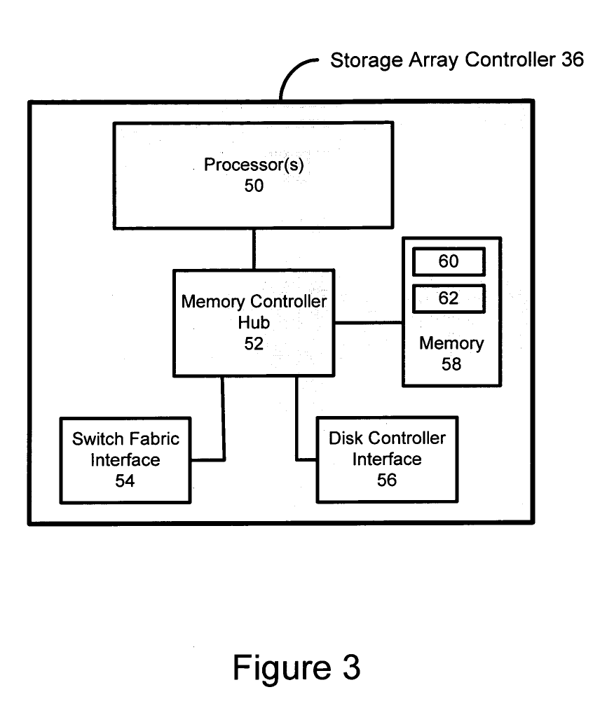

One embodiment of storage array controller 36 is now described in more detail with reference to FIG. 3. Storage array controller 38 and other storage array controllers connected to switched backplane 35 can be implemented in a similar manner. Storage array controller 36 includes a processor 50. Processor 50 may be implemented as a processing unit made up of two or more processors. The processor(s) 50 are connected to other components by memory controller hub 52. Memory controller hub 52 can be implemented, in one embodiment, using the E7500 series memory controller hub available from Intel® Corporation.

The memory controller hub 52 connects the processor(s) 50 to a memory 58. Memory 58 may be made up of several memory units, such as a DDRAM and other volatile memory, and a Flash Memory and other non-volatile memory. The instructions and configuration data necessary to run the storage array controller 36 are stored in memory 58, in one embodiment. The memory controller hub 52, in one embodiment, also connects the processor(s) 50 to a switch fabric interface 54 to couple the storage array controller 36 to the switched backplane 35 and a disk controller interface 56 to couple the storage array controller 36 to the disk controller 40. In one embodiment, these interfaces can be implemented using a Peripheral Component Interconnect (PCI) bridge.

In one embodiment of the invention, a disk failure prediction module (shown as block 60 in FIG. 3) is stored in memory 58. In one embodiment, the disk failure prediction module 60 is a collection of diagnostic and analytical tools to predict impending disk failure. The disk failure prediction module 60 can be implemented as firmware stored on a Flash or other non-volatile memory, or as software loaded into some other type of memory in memory 58.

In one embodiment, the disk failure prediction module 60 predicts disk failure in a manner somewhat similar to SMART. However, since the disk failure prediction module 60 is implemented on the platform level, it can be more accurate in disk failure prediction. For example, the diagnostic and analytical tools of the disk failure prediction module 60 can consider the running time of the platform as a factor when predicting disk failure. In contrast, SMART 25 would not have access to this information.

Since the disk failure prediction module 60 is implemented n the platform level—that is in the storage system such as a storage server or storage array controller indeed of a disk—the disk failure prediction module 60 can aggregate and collect information about multiple disks to predict disk failures. For example, SMART alerts from multiple disks can be considered when predicting a disk failure, not just information and operational statistics about a single disk, as is the case with SMART. Furthermore, since it is implemented at the platform level, the disk failure prediction module 60 can predict errant disks that are not provisioned with SMART.

Disk Failure Prediction

In one embodiment, the disk failure prediction module 60 uses a Bayesian Network for predicting imminent disk failures. A Bayesian network allows for using prior probabilities in order to predict a disk failure. Specifically, the probability of an event X given that event Y has occurred—expressed as P (X|Y)—is computable given a collection of event Y's. For disk failure prediction, event X would be the failure of a particular disk, and the event Y's would be the historical record of the platform in operation.

Bayesian networks are based upon the Bayes Theorem. The Bayes theorem is a formula used for calculating conditional probabilities. Failures in storage subsystems can be predicted by using Bayesian networks to learn about historical failures in order to build a database of prior probabilities. In certain embodiments, the learning for the Bayesian Network is accomplished by monitoring the frequency of certain failures, using as the prior statistics the number and time of failures. The data for the storage system may include tracking a failure location, time of failure, associated temperature, frequency of access, etc.

There are several method for calculating the probability of a disk failure in accordance with certain embodiments of the invention. For example, P(Bₙ₊₁|Bₙ) represents the probability that Data Blockₙ₊₁ may fail if Data Blockₙ (Bₙ) has failed. For the purposes of this example, the term “Data Block” with a subscript is used herein to refer to a block of data. In one embodiment, the Bayesian probability analysis is used to determine whether to perform migration of Data Blockₙ₊₁ if Data Blockₙ experiences a failure. For example, if it is likely that Data Blockₙ₊₁ may fail if Data Blockₙ has failed, it is useful to migrate or recovery Data Blockₙ₊₁ to avoid a later activity to retrieve Data Blockₙ₊₁, since this latter block has a high probability of future failure.

FIG. 3 is a flow diagram illustrating one embodiment of processing performed by the disk failure prediction module 30. In block 402, the disk failure prediction module collects and aggregates information about the disks accessible using the disk controller or disk controllers associated with the storage array controller. This information can include SMART alerts, detected disk failures, operating temperatures, and platform up-time, among various other things.

One benefit of collecting and aggregating this information at the platform level, i.e., at the storage sever or storage array controller level, is that information about other disks can be used for failure prediction. Such information can effectively be combined with Bayesian statistical analysis, since disk failures in disk arrays are often related. Thus, the probability that a disk will fail can be more accurately determined with information about other disks in the disk array.

In block 404, the information collected and aggregated is used to predict the likelihood that a specific disk in the disk array will fail. In one embodiment, these likelihoods are determined for all disks in the disk array. In another embodiment, only identified “trouble” disks get failure prediction analysis.

In one embodiment, Bayesian statistical analysis is used to determine the likelihood of disk failure. As explained above, Bayesian statistics is adaptable to predict disk failure provided information about other disks as well as the disk being predicted, and information available at the platform, such as up-time, platform processor usage, and so on. In other embodiments other statistical methods and schemes may be used, the present invention is not limited to the use of Bayesian networks.

In one embodiment, blocks 402 and 404 are performed continuously. That is information about the disks is continuously collected and aggregated, and the disk failure likelihoods are continuously updated as new information is collected. In another embodiment, information collection and aggregation is performed on a periodic basis. In one embodiment, the disk failure likelihoods are also updated on a periodic basis. The frequency of the periods can be adaptive based on the amount of processing bandwidth available to the disk failure prediction module 60.

Data Migration

Another module, shown as block 62 in FIG. 3, that can be implemented in the memory 58 of storage array controller 36 is a data migration module 62. The data migration module 62 can be implemented as firmware stored on a Flash or other non-volatile memory, or as software loaded into some other type of memory in memory 58. In one embodiment, the data migration module contains instructions and procedures that are called upon by the storage array controller 36 to move data resident on a disk predicted to fail by the disk failure prediction module 60 to another disk.

In one embodiment, the data migration module 62 performs the data migration by causing the storage array controller 36 to instruct the disk controller 40 to perform disk block migration on the affected data. Disk block migration is the movement of data from a data block that has a higher probability of failure to one that has a lower probability of failure, as determined by the disk failure prediction module 60. In one embodiment, this data block mapping occurs within the controller and is opaque to the system software (e.g., host operating system file system, etc).

In another embodiment, the data migration module 62 performs the data migration by causing the storage array controller 36 to instruct the disk controller 40 to trigger a RAID sparing event. A RAID sparing event is the use of a mirror drive or a redundant drive that is disjoint and independent of the failing device. This type of RAID sparing is known as RAID 0 or “mirroring”. Another RAID sparing event can include a hot-spare, or an idle drive that is available for mapping data from an errant device.

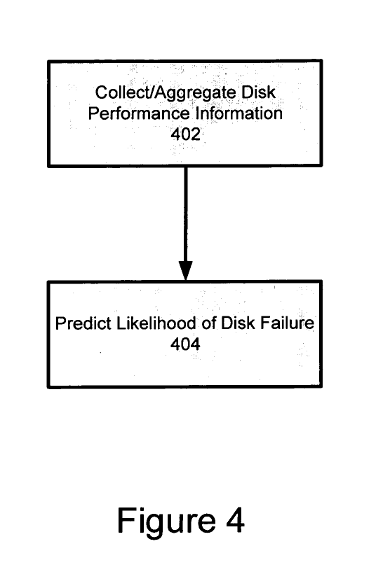

FIG. 4 is a flow diagram illustrating one embodiment of processing performed by the data migration module 62. In block 502, an errant disk is identified based on disk failure predictions determined by the disk failure prediction module 60. In one embodiment, the disk failure prediction module 60 determines likelihoods of failure for all disks managed by the storage array controller, and the data migration module identifies errant disks using these probabilities. In another embodiment, the disk failure prediction module 60 delineates the boundary that defines an errant disk based on the calculated disk failure probabilities, and provides a list or errant disks to the data migration module 62. Thus, some functionalities of the disk failure prediction module 60 and the data migration module can be implemented in either, or without dividing these task between the modules at all. These modules are set forth merely as an example modular implementation.

In one embodiment, identifying an errant disk can be done by observing that the probability of failure associated with a disk exceeds a threshold. For example, a disk can be defined as errant if there is an 80 or more percent chance that the disk will fail. Other definitions can also add a temporal element, such as 80 or more percent chance that the disk will fail within a day (or hour, or minute and so on).

In block 504, the data on the errant disk (or disk block) is migrated to a healthy disk. In one embodiment, the data migration module 62 can select any disk defined as healthy by having a probability of failure below a threshold. This threshold may be the same as that that defines an errant disk, or it may be a different, lower threshold. The healthy disk can be selected from a group of healthy disks managed by the storage array controller using any number of criteria. Such criteria can include disk usage, disk grouping, and past disk reliability, among other things.

In one embodiment, disk migration can be carried out by triggering a RAID sparing or mirroring event. Thus, in this embodiment, the system can use the RAID functionality already provisioned on the disks and disk controllers that implement RAID to perform data migration. Ordinary RAID mirroring constantly maintains a redundant copy of data which can be used to restore data lost when a disk fails. In contrast, a system using an embodiment of the present invention only performs a RAID mirror when a disk becomes errant and likely to fail. The RAID mirroring is used as automated self-healing as opposed to reactive data restoration.

Example Computer

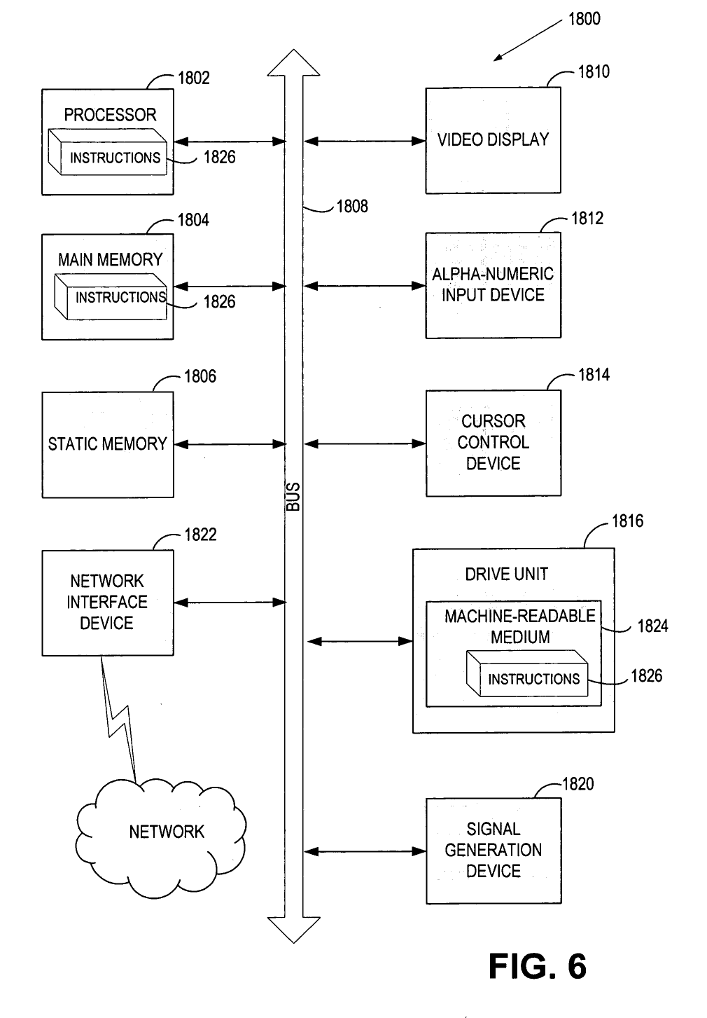

In the description above, various embodiments have been described in the context of a storage array controller. However, embodiments of the present invention can be implemented in other computing and processing systems that have multiple storage components such as disks that might fail. Various embodiment of the present invention can be implemented on generic storage servers, web servers, and even personal computers and mobile computers. One such generic computing environment in which embodiments of the present invention can be implemented is now described with reference to FIG. 6.

Computer system 1800 that may be used to perform one or more of the operations described herein. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1800 includes a processor 1802, a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alpha-numeric input device 1812 (e.g., a keyboard), a cursor control device 1814 (e.g., a mouse), a disk drive unit 1816, a signal generation device 1820 (e.g., a speaker) and a network interface device 1822.

The disk drive unit 1816 includes a machine-readable medium 1824 on which is stored a set of instructions (i.e., software) 1826 embodying any one, or all, of the methodologies described above. The software 1826 is also shown to reside, completely or at least partially, within the main memory 1804 and/or within the processor 1802. The software 1826 may further be transmitted or received via the network interface device 1822. For the purposes of this specification, the term “machine-readable medium” shall be taken to include any medium that is capable of storing or encoding a sequence of instructions for execution by the computer and that cause the computer to perform any one of the methodologies of the present invention. The term “machine-readable medium” shall accordingly be taken to included, but not be limited to, solid-state memories, optical and magnetic disks, and carrier wave signals.

General Matters

In the description above, for the purposes of explanation, numerous specific details have been set forth. However, it is understood that embodiments of the invention may be practiced without these specific details. In other instances, well-known circuits, structures and techniques have not been shown in detail in order not to obscure the understanding of this description.

Embodiments of the present invention include various processes. The processes may be performed by hardware components or may be embodied in machine-executable instructions, which may be used to cause one or more processors programmed with the instructions to perform the processes. Alternatively, the processes may be performed by a combination of hardware and software.

Aspects of some of the embodiments of the present invention may be provided as a coded instructions (e.g., a computer program, software/firmware module, etc.) that may be stored on a machine-readable medium, which may be used to program a computer (or other electronic device) to perform a process according to one or more embodiments of the present invention. The machine- readable medium may include, but is not limited to, floppy diskettes, optical disks, compact disc read-only memories (CD-ROMs), and magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A storage server comprising:
a disk failure prediction module to collect information about a plurality of disks associated with the storage server, and to determine disk failure likelihoods for the plurality of disks based on the information collected about the plurality of disks.

2. The storage server of claim 1, further comprising a data migration module to identify an errant disk based on the disk failure likelihoods, the errant disk having a high likelihood of failure.

3. The storage server of claim 2, wherein the data migration module migrates data from the errant disk to a healthy disk in response to identifying the errant disk, the healthy disk having a low likelihood of failure.

4. The storage server of claim 1, wherein the disk failure prediction module collects Self Monitoring and Reporting Technology (SMART) alerts from the plurality of disks to be used in determining the disk failure likelihoods.

5. The storage server of claim 1, wherein the disk failure prediction module collects information about operating temperatures associated with the plurality of disks to be used in determining the disk failure likelihoods.

6. The storage server of claim 1, wherein the disk failure prediction module determines the disk failure likelihoods by performing a statistical analysis of the information collected about the plurality of disks.

7. The storage server of claim 6, wherein the statistical analysis comprises a Bayesian analysis.

8. The storage server of claim 3, wherein the data migration module migrates the data from the errant disk to a healthy disk by triggering a redundant array of independent disks (RAID) mirroring event.

9. A storage system comprising:
a plurality of channel adapters to connect to a storage attached network (SAN) fabric;
a storage array controller coupled to the plurality of channel adapters by a switched backplane;
a disk controller coupled to the storage array controller to couple the storage array controller to an array of disks associated with the storage array controller;
wherein the storage array controller collects information about disks in the array of disks associated with the storage server and identifies an errant disk having a high likelihood of future failure based on the collected information.

10. The storage system of claim 9, wherein the storage array controller migrates data from the errant disk to a healthy disk by triggering a redundant array of independent disks (RAID) sparing event using the disk controller.

11. The storage system of claim 9, wherein storage array controller aggregates Self Monitoring and Reporting Technology (SMART) alerts from the array of disks and uses the SMART alerts to identify the errant disk.

12. A method performed by a storage system, the method comprising:
collecting information about a plurality of disks; and
predicting that a first disk will fail based on the information collected about the plurality of disks.

13. The method of claim 12, further comprising migrating data from the first disk to a second disk in response to predicting that the first disk will fail.

14. The method of claim 12, wherein collecting information comprises collecting Self Monitoring and Reporting Technology (SMART) alerts from the plurality of disks.

15. The method of claim 12, wherein collecting information comprises collecting information about operating temperatures associated with the plurality of disks.

16. The method of claim 13, wherein the first disk and the second disk belong to the plurality of disks.

17. The method of claim 12, wherein predicting that the first disk will fail comprises performing a statistical analysis of the information collected about the plurality of disks.

18. The method of claim 17, wherein the statistical analysis comprises a Bayesian analysis.

19. The method of claim 13, wherein migrating data from the first disk to the second disk comprises triggering a redundant array of independent disks (RAID) mirroring event to copy data from the first disk to the second disk.

20. A machine-readable medium having stored thereon data representing instruction that, when executed by a processor, cause the processor to perform operations comprising:
collecting information about a plurality of disks; and
predicting that a first disk has a high likelihood of failure based on the information collected about the plurality of disks.

21. The machine-readable medium of claim 20, wherein the instructions further cause the processor to migrate data from the first disk to a second disk, the second disk having a lower likelihood of failure than the first disk.

22. The machine-readable medium of claim 20, wherein collecting information comprises collecting Self Monitoring and Reporting Technology (SMART) alerts from the plurality of disks.

23. The machine-readable medium of claim 20, wherein collecting information comprises collecting information about operating temperatures associated with the plurality of disks.

24. The machine-readable medium of claim 21, wherein the first disk and the second disk belong to the plurality of disks.

25. The machine-readable medium of claim 20, wherein predicting that the first has a high likelihood of failure comprises performing a statistical analysis of the information collected about the plurality of disks.

26. The machine-readable medium of claim 21, wherein migrating data from the first disk to the second disk comprises triggering a redundant array of independent disks (RAID) mirroring event to copy data from the first disk to the second disk.
